(19) United States
(12) Patent Application Publication
(10) Pub. No.: US 2018/0086372 A1
(43) Pub. Date: Mar. 29, 2018

(54) STEERING CONTROL DEVICE

(71) Applicant: TOYOTA JIDOSHA KABUSHIKI KAISHA, Toyota-shi (JP)

(72) Inventor: Rio SUDA, Susono-shi (JP)

(73) Assignee: TOYOTA JIDOSHA KABUSHIKI KAISHA, Toyota-shi (JP)

(21) Appl. No.: 15/658,744

(22) Filed: Jul. 25, 2017

(30) Foreign Application Priority Data
Sep. 23, 2016 (JP) 2016-185430

(51) Int. Cl. B62D 6/00; B62D 6/08; B62D 7/15

(52) U.S. Cl. CPC B62D 6/002; B62D 7/15; B62D 6/08

(57) ABSTRACT

A steering control device for a vehicle, has: a control device configured to calculate a target rear steering angle that is represented as a function of an input parameter including a steering wheel angle; and a rear wheel turning device configured to turn a rear wheel of the vehicle according to the target rear steering angle. When a correction condition that the vehicle is in a oversteer condition and a driver applies counter-steering is satisfied, the control device executes correction processing that corrects the function. With respect to a same input parameter, an absolute value of the target rear steering angle calculated when the correction processing is in execution is smaller than an absolute value of the target rear steering angle calculated when the correction processing is not in execution.

### BACKGROUND

### Technical Field

The present invention relates to a steering control device for a vehicle capable of four wheel steering (4WS).

### Background Art

Patent Literature 1 discloses a steering device for a vehicle capable of 4WS. The steering device calculates, based on a steering wheel angle and a vehicle speed, a target yaw rate and a target lateral acceleration as motion target values of the vehicle. Here, a control gain and a time constant used for calculating the motion target values are designed freely and provided as a map beforehand. The steering device calculates respective target steering angles of a front wheel and a rear wheel such that the calculated motion target values are obtained. Then, the steering device drives a front wheel turning actuator and a rear wheel turning actuator such that the calculated target steering angles are achieved.

### LIST OF RELATED ART

Patent Literature 1: JP-2008-006952

### SUMMARY

Let us consider drift running of a vehicle that calculates target steering angles to perform 4WS as in the case of the above-mentioned Patent Literature 1. In a drift state, a slip angle of a rear wheel is increased to an extent that the rear wheel skids. A driver applies counter-steering in order to maintain the drift state. When the driver applies the counter-steering, the target steering angle of the rear wheel is calculated accordingly, and a steering angle of the rear wheel is changed according to the calculated target steering angle. In this case, when the slip angle of the rear wheel becomes smaller, an oversteer condition namely the drift state of the vehicle becomes more likely to be cancelled. That is to say, as compared with a case of 2WS where the steering angle of the rear wheel does not change, the drift state may be more difficult to maintain in the case of the 4WS, which is contrary to the driver's intention to maintain the drift state. A vehicle behavior contrary to the driver's intention or a vehicle behavior beyond the driver's expectation makes the driver feel strange.

An object of the present invention is to provide a technique that can achieve a vehicle behavior according to a driver's intention during drift running of a vehicle capable of 4WS.

A first invention provides a steering control device for a vehicle.

The steering control device has:

a control device configured to calculate a target rear steering angle that is represented as a function of an input parameter including a steering wheel angle; and

a rear wheel turning device configured to turn a rear wheel of the vehicle according to the target rear steering angle.

When a correction condition that the vehicle is in a oversteer condition and a driver applies counter-steering is satisfied, the control device executes correction processing that corrects the function.

With respect to a same input parameter, an absolute value of the target rear steering angle calculated when the correction processing is in execution is smaller than an absolute value of the target rear steering angle calculated when the correction processing is not in execution.

A second invention further has the following features in addition to the first invention.

The function includes a product of a steady-state gain and the steering wheel angle.

In the correction processing, the control device makes the steady-state gain when the correction condition is satisfied smaller than the steady-state gain when the correction condition is not satisfied.

A third invention further has the following features in addition to the first or second invention.

The function includes a product of a derivative gain and an angular velocity of the steering wheel angle.

In the correction processing, the control device makes the derivative gain when the correction condition is satisfied smaller than the derivative gain when the correction condition is not satisfied.

A fourth invention further has the following features in addition to any one of the first to third inventions.

After the correction processing is started and when the correction condition ceases to be satisfied and a steering wheel passes a neutral position, the control device terminates the correction processing to restore the function.

According to the first invention, the correction condition that “the vehicle is in a oversteer condition and the driver applies counter-steering” is taken into consideration. A case where the correction condition is satisfied corresponds to a state where the driver has an intention to maintain the drift state. In the case where the correction condition is satisfied, the function used for calculating the target rear steering angle is corrected. More specifically, the function is corrected such that the absolute value of the target rear steering angle calculated with respect to the same input parameter becomes smaller. This means that steering characteristics change from 4WS characteristics to be closer to 2WS characteristics. That is to say, when it is estimated that the driver has the intention to maintain the drift state, the steering characteristics change from the 4WS characteristics to be closer to the 2WS characteristics. Therefore, occurrence of a vehicle behavior contrary to the driver's intention or a vehicle behavior beyond the driver's expectation can be suppressed. As a result, the driver's feeling of strangeness during the drift running is reduced. It is possible to achieve a vehicle behavior and controllability according to the driver's intention during the drift running.

According to the second invention, the function includes the product of the steady-state gain and the steering wheel angle. When the correction condition is satisfied, the steady-state gain is reduced, and thereby the absolute value of the target rear steering angle to be calculated can be reduced.

According to the third invention, the function includes the product of the derivative gain and the angular velocity of the steering wheel angle. When the correction condition is satisfied, the derivative gain is reduced, and thereby the absolute value of the target rear steering angle to be calculated can be reduced.

According to the fourth invention, when the correction condition ceases to be satisfied and the steering wheel passes the neutral position, the correction processing is terminated to restore the function. At the timing when the function is restored, the calculated target rear steering angle may undergo a discontinuous change, which may cause the driver to feel strange about the vehicle behavior. However, by restoring the function at a timing when the steering wheel is near the neutral position, it is possible to suppress such the discontinuous change. As a result, the driver's feeling of strangeness upon termination of the correction processing is reduced.

### BRIEF DESCRIPTION OF DRAWINGS

FIG. 1 is a schematic diagram showing an example of drift running of a vehicle;

FIG. 2 is a conceptual diagram for explaining correction processing in an embodiment of the present invention;

FIG. 3 is a schematic diagram showing a configuration example of a vehicle according to a first embodiment of the present invention;

FIG. 4 is a block diagram showing a functional configuration of an ECU in the first embodiment;

FIG. 5 is a conceptual diagram showing an example of a function used for calculating a target steering angle from an input parameter in the first embodiment;

FIG. 6 is a flow chart showing in a summarized manner a steering control according to the first embodiment;

FIG. 7 is a flow chart showing processing of calculating the target steering angle in the first embodiment;

FIG. 8 is a schematic diagram showing a configuration example of a vehicle according to a second embodiment of the present invention; and

FIG. 9 is a block diagram showing a functional configuration of an ECU in the second embodiment.

### EMBODIMENTS

Embodiments of the present invention will be described below with reference to the attached drawings.

### 1. Outline

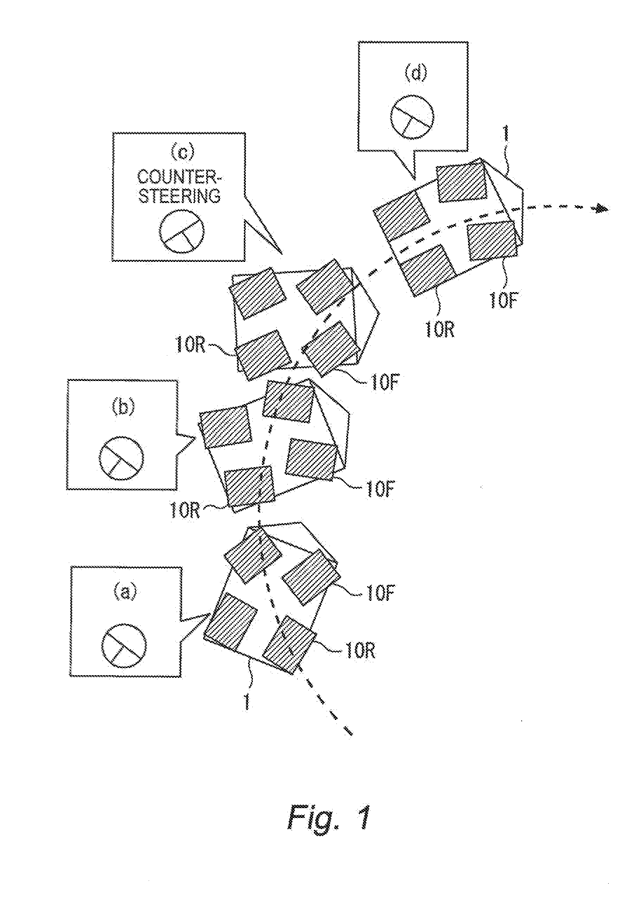

FIG. 1 is a schematic diagram showing an example of drift running of a vehicle 1. The vehicle 1 has front wheels 10F and rear wheels 10R. A steering direction of a steering wheel by a driver as well as respective orientations of the front wheels 10F and the rear wheels 10R are schematically shown in FIG. 1.

STATE (a) represents a stage where the vehicle 1 goes into a drift state. The driver turns the steering wheel to the right, and the vehicle 1 turns clockwise. Then, the rear wheel 10R skids greatly, a slip angle of the rear wheel 10R is increased, and the vehicle 1 becomes an oversteer condition. In STATE (b), the driver keeps turning the steering wheel to the right, and the slip angle of the rear wheel 10R is further increased.

In STATE (c), in order to continue the drift state, the driver turns the steering wheel to the left, namely applies “counter-steering”. At this time also, the vehicle 1 is in the oversteer condition. Such the state where the vehicle 1 is in the oversteer condition and the driver applies the counter-steering means that the driver has an intention to maintain the drift state.

STATE (d) represents a stage where the vehicle 1 returns from the drift state. The driver terminates the counter-steering and returns the steering wheel to neutral or turns the steering wheel to the right. Respective gripping forces of the front wheels 10F and the rear wheels 10R recover and the drift state ends.

Here, let us consider a case where the vehicle 1 is capable of 4WS, that is, a steering angle not only of the front wheel 10F but also of the rear wheel 10R changes. In this case, at least a target steering angle of the rear wheel 10R is automatically calculated by the vehicle 1. More specifically, the target steering angle (hereinafter referred to as a “target rear steering angle δr”) of the rear wheel 10R is represented as a function of a predetermined input parameter including a steering wheel angle MA being a steering angle of the steering wheel. When the driver operates the steering wheel, the vehicle 1 calculates the target rear steering angle δr in a feedforward manner based on the above-mentioned function and the input parameter including the steering wheel angle MA. Then, the vehicle 1 performs a turning control of the rear wheel 10R such that the steering angle of the rear wheel 10R becomes the target rear steering angle δr.

Next, regarding the vehicle 1 capable of 4WS, let us consider the above-mentioned STATE (c) in the drift running. When the driver applies the counter-steering, the steering angle not only of the front wheel 10F but also of the rear wheel 10R changes. Here, the target rear steering angle δr is calculated based on the input parameter and the function as described above. For example, when turning of the rear wheel 10R is controlled to be in the same direction as that of the front wheel 10F, the rear wheel 10R is oriented to the left similarly to the front wheel 10F as shown in FIG. 1. As a result, the slip angle of the rear wheel 10R becomes smaller as compared with a case of 2WS where the steering angle of the rear wheel 10R does not change.

The fact that the slip angle of the rear wheel 10R becomes smaller in STATE (c) means that the oversteer condition of the vehicle 1 is more likely to be cancelled. That is to say, as compared with the case of the 2WS where the steering angle of the rear wheel does not change, the drift state is more difficult to maintain in the case of the 4WS shown in FIG. 1, which is contrary to the driver's intention in STATE (c) to maintain the drift state. The driver feels strange about a vehicle behavior contrary to the driver's intention. Moreover, when the driver performs the counter-steering with the same feeling as in the case of the 2WS, the driver feels strange because the vehicle behavior changes more than expected.

In this manner, during the drift running of the vehicle capable of the 4WS, the vehicle behavior contrary to the driver's intention or the vehicle behavior beyond the driver's expectation is likely to occur. Such the vehicle behavior makes the driver feel strange. Moreover, such the vehicle behavior is undesirable for the driver who wants to control the drift running as the driver likes.

In view of the above, according to the present embodiment, processing for changing steering characteristics in STATE (c) from 4WS characteristics to be closer to 2WS characteristics is performed. More specifically, detection of STATE (c) is first performed. To that end, it is determined whether a condition that “the vehicle 1 is in the oversteer condition and the driver applies the counter-steering” is satisfied or not. A case where this condition is satisfied corresponds to STATE (c), where the driver has an intention to maintain the drift state. Therefore, if STATE (c) is detected, the processing for changing the steering characteristics from the 4WS characteristics to be closer to the 2WS characteristics is performed in order to maintain the drift state for longer time. Specifically, the above-mentioned function used for calculating the target rear steering angle δr from the input parameter is corrected. More specifically, the above-mentioned function is corrected such that an absolute value of the target rear steering angle δr calculated with respect to the same input parameter becomes smaller.

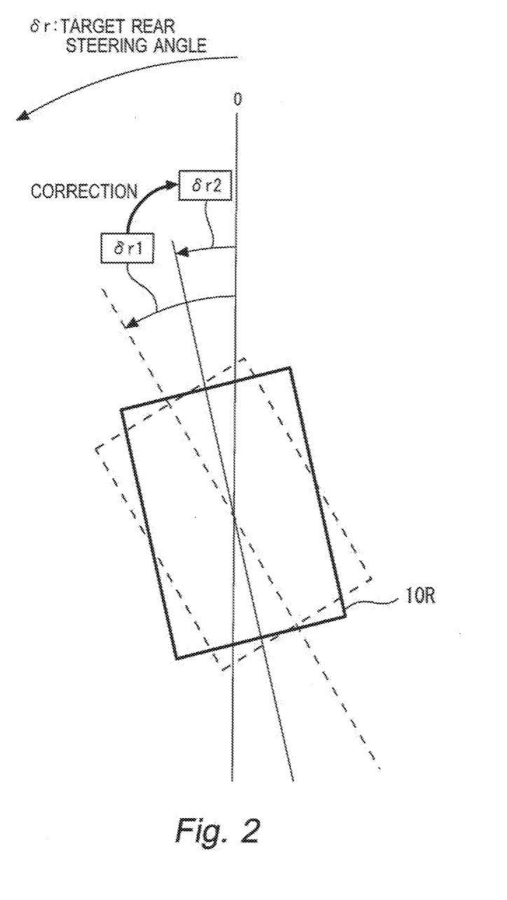

FIG. 2 is a conceptual diagram for explaining the above-described correction in the present embodiment. The rear wheel 10R and the target rear steering angle δr are illustrated in FIG. 2. The target rear steering angle δr calculated with respect to a certain input parameter when the function is not corrected is denoted by “δr1”. On the other hand, the target rear steering angle δr calculated with respect to the same input parameter when the function is corrected is denoted by “δr2”. An absolute value of the target rear steering angle δr2 is smaller than an absolute value of the target rear steering angle δr1. The fact that the absolute value of the target rear steering angle δr2 becomes smaller means that the steering characteristics of the vehicle 1 becomes closer to the 2WS characteristics. In particular, when the target rear steering angle δr2 is set to zero, the steering angle of the rear wheel 10R becomes zero and thus the vehicle 1 behaves like a 2WS vehicle.

As described above, according to the present embodiment, when the condition that “the vehicle 1 is in the oversteer condition and the driver applies the counter-steering” is satisfied, the function is corrected such that the steering characteristics becomes closer to the 2WS characteristics. The condition can be called a “correction condition” for correcting the function.

The case where the correction condition is satisfied corresponds to STATE (c) where the driver has the intention to maintain the drift state. According to the present embodiment, the steering characteristics in STATE (c) becomes closer to the 2WS characteristics. Therefore, occurrence of the vehicle behavior contrary to the driver's intention or the vehicle behavior beyond the driver's expectation is suppressed. As a result, the driver's feeling of strangeness during the drift running is reduced. That is, according to the present embodiment, it is possible to achieve the vehicle behavior and controllability according to the driver's intention during the drift running.

### 2. First Embodiment

### 2-1. General Configuration

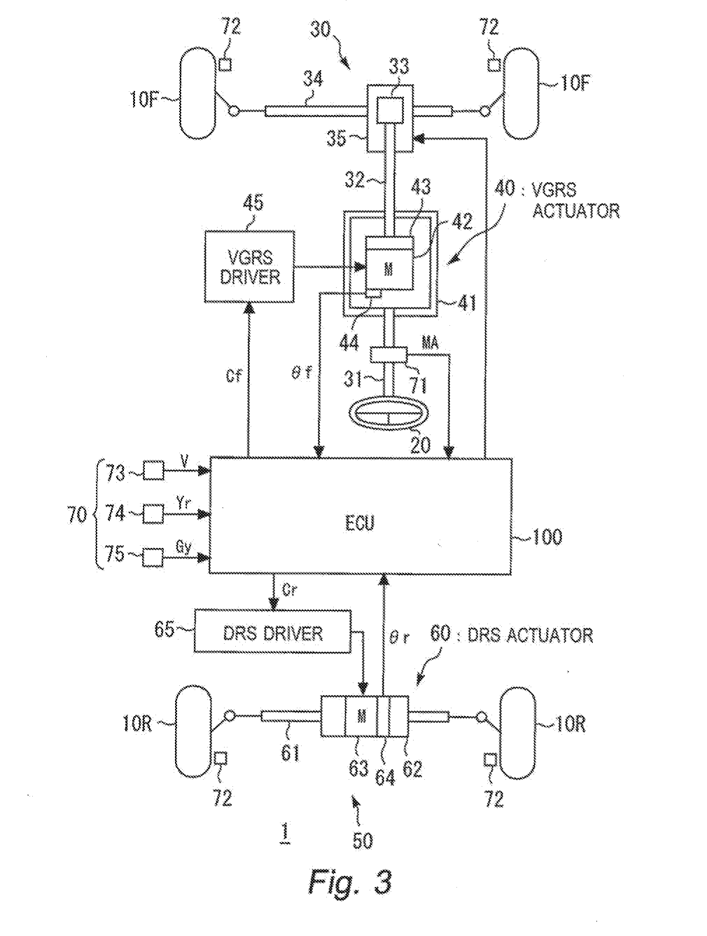

FIG. 3 is a schematic diagram showing a configuration example of the vehicle 1 according to a first embodiment of the present invention. The vehicle 1 according to the present embodiment is configured to be capable of the 4WS. More specifically, the vehicle 1 is provided with the front wheels 10F, the rear wheels 10R, a steering wheel 20, a front wheel turning device 30, a rear wheel turning device 50, a sensor group 70, and an ECU (Electronic Control Unit) 100.

### <Steering Wheel 20>

The steering wheel 20 is used for a steering operation by the driver. That is, the driver turns the steering wheel 20 when the driver wants to turn the front wheel 10F and the rear wheel 10R.

### <Front Wheel Turning Device 30>

The front wheel turning device 30 is a device for turning the front wheel 10F. The front wheel turning device 30 has an upper steering shaft 31, a lower steering shaft 32, a pinion gear 33, a rack bar 34, an EPS (Electronic Power Steering) actuator 35, a VGRS (Variable Gear Ratio Steering) actuator 40, and a VGRS driver 45.

The upper steering shaft 31 is connected to the steering wheel 20. One end of the lower steering shaft 32 is connected to the upper steering shaft 31 through the VGRS actuator 40, and the other end thereof is connected to the pinion gear 33. The pinion gear 33 engages with the rack bar 34. Both ends of the rack bar 34 are respectively connected to the left and right front wheels 10F. A rotation of the steering wheel 20 is transmitted to the pinion gear 33 through the upper steering shaft 31, the VGRS actuator 40, and the lower steering shaft 32. A rotational motion of the pinion gear 33 is converted into a linear motion of the rack bar 34, and thereby the steering angle of the front wheel 10F changes.

The EPS actuator 35 is a device for generating a steering torque to assist turning of the front wheel 10F. The EPS actuator 35 includes an electric motor and generates the steering torque by a rotation of the electric motor. The EPS actuator 35 applies the steering torque to the pinion gear 33, for example. A rotating operation of the electric motor of the EPS actuator 35 is controlled by the ECU 100.

The VGRS actuator 40 is so provided as to connect between the upper steering shaft 31 and the lower steering shaft 32. The VGRS actuator 40 includes a housing 41, an electric motor 42, a speed reducer 43, and a rotation angle sensor 44. The electric motor 42, the speed reducer 43, and the rotation angle sensor 44 are housed in the housing 41.

The housing 41 is fastened to one end of the upper steering shaft 31 and rotates together with the upper steering shaft 31. A stator of the electric motor 42 is fixed within the housing 41. On the other hand, a rotor of the electric motor 42 is rotatably supported within the housing 41. A rotation axis of the electric motor 42 is connected to the lower steering shaft 32 through the speed reducer 43. The rotation angle sensor 44 detects a rotation angle θf of the rotor of the electric motor 42 and outputs the detected information on the rotation angle θf to the ECU 100.

By controlling the rotation of the electric motor 42 of the VGRS actuator 40 thus configured, it is possible to variably control a steering gear ratio. Here, the steering gear ratio is a ratio of a steering angle (steering wheel angle MA) of the steering wheel 20 and a steering angle of the front wheel 10F, and is proportional to a ratio of a rotation angle of the upper steering shaft 31 and a rotation angle of the lower steering shaft 32.

The VGRS driver 45 is a device for driving the electric motor 42, and includes an inverter and so forth. The inverter converts DC power supplied from a DC power source (not shown) to AC power and supplies the AC power to the electric motor 42 to drive the electric motor 42.

An operation of the VGRS driver 45 is controlled by the ECU 100. More specifically, the ECU 100 calculates, based on the input parameter, a target steering angle (hereinafter referred to as a “target front steering angle δf”) of the front wheel 10F. Subsequently, the ECU 100 calculates a target rotation angle of the electric motor 42 with which the steering angle of the front wheel 10F becomes the target front steering angle δf. Then, the ECU 100 generates, based on the target rotation angle of the electric motor 42, a control signal Cf used for controlling the operation of the VGRS driver 45. The ECU 100 supplies the generated control signal Cf to the VGRS driver 45, and the VGRS driver 45 drives the electric motor 42 in accordance with the control signal Cf. Meanwhile, the ECU 100 receives the detected information on the rotation angle θf of the electric motor 42 from the rotation angle sensor 44. The ECU 100 performs a feedback control such that the rotation angle θf becomes the target rotation angle. In this manner, the steering angle of the front wheel 10F is controlled to be the target front steering angle δf.

According to the present embodiment, as described above, the steering angle of the front wheel 10F varies depending on the target front steering angle δf calculated by the ECU 100. It can be said that the front wheel turning device 30 turns the front wheel 10F according to the target front steering angle δf calculated by the ECU 100.

### <Rear Wheel Turning Device 50>

The rear wheel turning device 50 is a device for turning the rear wheel 10R. The rear wheel turning device 50 has a DRS (Dynamic Rear Steering) actuator 60 and a DRS driver 65.

The DRS actuator 60 includes a turning bar 61, a ball screw 62, an electric motor 63, and a rotation angle sensor 64. Both ends of the turning bar 61 are respectively connected to the left and right rear wheels 10R. The ball screw 62 is provided between the turning bar 61 and the electric motor 63. When a rotor of the electric motor 63 rotates, the ball screw 62 converts the rotational motion into a linear motion of the turning bar 61, and thereby the steering angle of the rear wheel 10R changes. The rotation angle sensor 64 detects a rotation angle θr of the rotor of the electric motor 63 and outputs the detected information on the rotation angle θr to the ECU 100.

The DRS driver 65 is a device for driving the electric motor 63, and includes an inverter and so forth. The inverter converts DC power supplied from a DC power source (not shown) to AC power and supplies the AC power to the electric motor 63 to drive the electric motor 63.

An operation of the DRS driver 65 is controlled by the ECU 100. More specifically, the ECU 100 calculates, based on the input parameter, the target rear steering angle δr described above. Subsequently, the ECU 100 calculates a target rotation angle of the electric motor 63 with which the steering angle of the rear wheel 10R becomes the target rear steering angle δr. Then, the ECU 100 generates, based on the target rotation angle of the electric motor 63, a control signal Cr used for controlling the operation of the DRS driver 65. The ECU 100 supplies the generated control signal Cr to the DRS driver 65, and the DRS driver 65 drives the electric motor 63 in accordance with the control signal Cr. Meanwhile, the ECU 100 receives the detected information on the rotation angle θr of the electric motor 63 from the rotation angle sensor 64. The ECU 100 performs a feedback control such that the rotation angle θr becomes the target rotation angle. In this manner, the steering angle of the rear wheel 10R is controlled to be the target rear steering angle δr.

According to the present embodiment, as described above, the steering angle of the rear wheel 10R varies depending on the target rear steering angle δr calculated by the ECU 100. It can be said that the rear wheel turning device 50 turns the rear wheel 10R according to the target rear steering angle δr calculated by the ECU 100.

### <Sensor Group 70>

The sensor group 70 is provided for detecting a variety of state quantities of the vehicle 1. For example, the sensor group 70 includes a steering angle sensor 71, wheel speed sensors 72, a vehicle speed sensor 73, a yaw rate sensor 74, and a lateral acceleration sensor 75.

The steering angle sensor 71 detects a steering wheel angle MA that is the steering angle of the steering wheel 20. The steering angle sensor 71 outputs detected information indicating the detected steering wheel angle MA to the ECU 100.

The wheel speed sensor 72 is provided with respect to each wheel and detects a rotational speed of the corresponding wheel. The wheel speed sensor 72 outputs detected information indicating the detected rotational speed to the ECU 100.

The vehicle speed sensor 73 detects a vehicle speed V that is a speed of the vehicle 1. The vehicle speed sensor 73 outputs detected information indicating the detected vehicle speed V to the ECU 100.

The yaw rate sensor 74 detects an actual yaw rate Yr of the vehicle 1. The yaw rate sensor 74 outputs detected information indicating the detected actual yaw rate Yr to the ECU 100.

The lateral acceleration sensor 75 detects an actual lateral acceleration Gy acting on the vehicle 1. The lateral acceleration sensor 75 outputs detected information indicating the detected actual lateral acceleration Gy to the ECU 100.

### <ECU 100>

The ECU 100 is a control device for controlling steering processing according to the present embodiment. Typically, the ECU 100 is a microcomputer including a processor, a memory, and an input/output interface. The ECU 100 receives the detected information from a variety of sensors (44, 64, 70) and sends instructions to a variety of drivers (45, 65) through the input/output interface. A control program is stored in the memory, and the processor executes the control program to achieve functions of the ECU 100. The control program may be recorded on a computer-readable recording medium.

Note that the steering wheel 20, the front wheel turning device 30, the rear wheel turning device 50, the sensor group 70, and the ECU 100 described above constitute a “steering control device” according to the present embodiment.

### 2-2. Functional Blocks of ECU 100

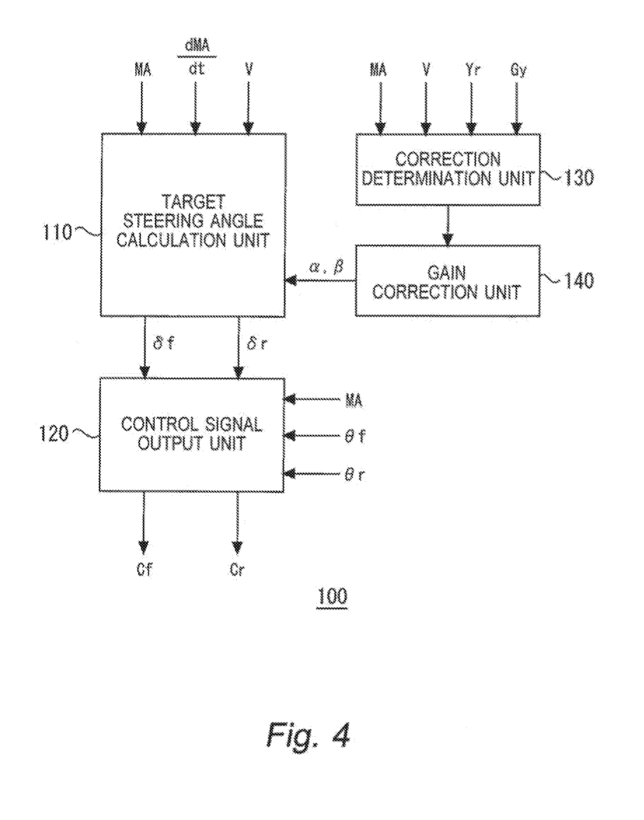

FIG. 4 is a block diagram showing a functional configuration of the ECU 100 in the present embodiment. The ECU 100 includes a target steering angle calculation unit 110, a control signal output unit 120, a correction determination unit 130, and a gain correction unit 140. These functional blocks are achieved by the processor of the ECU 100 executing the control program stored in the memory.

### <Target Steering Angle Calculation Unit 110>

The target steering angle calculation unit 110 calculates the target front steering angle δf and the target rear steering angle δr based on the input parameter.

In the present embodiment, the input parameter includes the steering wheel angle MA, a steering wheel angular velocity dMA/dt, and the vehicle speed V. The steering wheel angle MA is detected by the steering angle sensor 71. The steering wheel angular velocity dMA/dt is calculated from a series of temporally-successive detected values of the steering wheel angle MA. The vehicle speed V is detected by the vehicle speed sensor 73. Alternatively, the vehicle speed V may be calculated from the respective rotational speeds of the wheels detected by the wheel speed sensors 72.

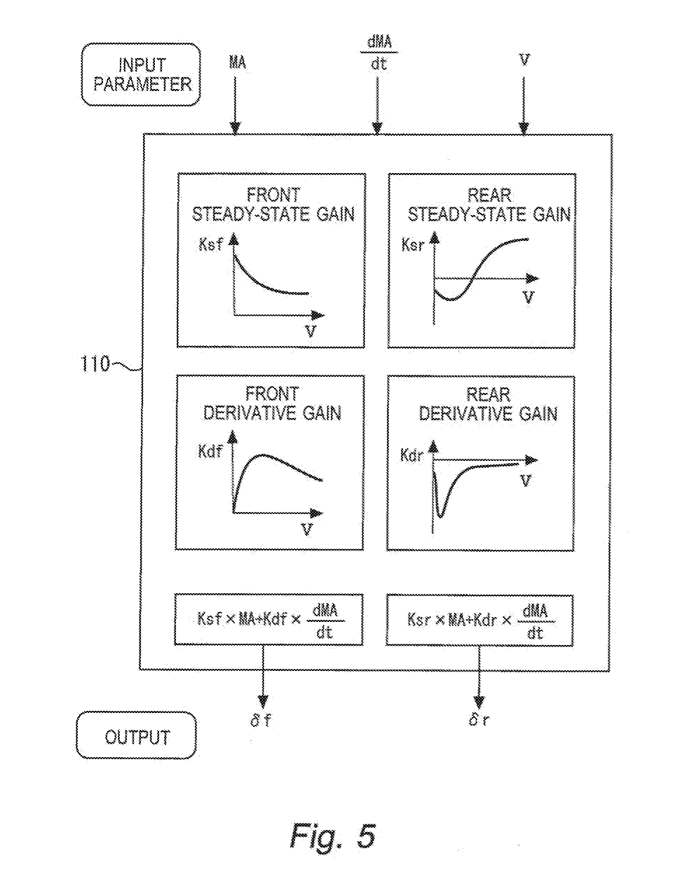

Each of the target front steering angle δf and the target rear steering angle δr is represented as a function of the input parameter. The target steering angle calculation unit 110 retains such the function, and uses the input parameter and the function to calculate the target front steering angle δf and the target rear steering angle δr. FIG. 5 conceptually shows an example of the function. In the present embodiment, the target front steering angle δf and the target rear steering angle δr are represented by the following equations (1) and (2), respectively.

$$\begin{matrix}[ Equation 1 ] & \\ δ f ∝ Ksf \times MA + Kdf \times \frac{dMA}{dt} & ( 1 ) \\ [ Equation 2 ] & \\ δ r ∝ Ksr \times MA + Kdr \times \frac{dMA}{dt} & ( 2 )\end{matrix}$$

The function for calculating the target front steering angle δf includes a sum of a product of a front steady-state gain Ksf and the steering wheel angle MA and a product of a front derivative gain Kdf and the steering wheel angular velocity dMA/dt. As shown in FIG. 5, each of the front steady-state gain Ksf and the front derivative gain Kdf is designed to vary depending on the vehicle speed V and provided as a gain map. The target steering angle calculation unit 110 retains such the gain map, and obtains the front steady-state gain Ksf and the front derivative gain Kdf according to the vehicle speed V. Then, the target steering angle calculation unit 110 uses the obtained gains, the steering wheel angle MA, and the steering wheel angular velocity dMA/dt to calculate the target front steering angle δf in a feedforward manner.

Similarly, the function for calculating the target rear steering angle δr includes a sum of a product of a rear steady-state gain Ksr and the steering wheel angle MA and a product of a rear derivative gain Kdr and the steering wheel angular velocity dMA/dt. As shown in FIG. 5, each of the rear steady-state gain Ksr and the rear derivative gain Kdr is designed to vary depending on the vehicle speed V and provided as a gain map. The target steering angle calculation unit 110 retains such the gain map, and obtains the rear steady-state gain Ksr and the rear derivative gain Kdr according to the vehicle speed V. Then, the target steering angle calculation unit 110 uses the obtained gains, the steering wheel angle MA, and the steering wheel angular velocity dMA/dt to calculate the target rear steering angle δr in a feedforward manner.

It should be noted that the gain map shown in FIG. 5 is determined based on desired vehicle characteristics (target vehicle characteristics). For example, the target vehicle characteristics include steady-state characteristics regarding a yaw rate and a slip angle, and transient characteristics regarding a lateral acceleration and a yaw rate. Each gain is designed such that the target vehicle characteristics are achieved, and then provided as the gain map.

### <Control Signal Output Unit 120>

The control signal output unit 120 generates the control signals Cf and Cr, respectively, based on the target front steering angle δf and the target rear steering angle δr calculated by the target steering angle calculation unit 110.

More specifically, the control signal output unit 120 calculates, based on the steering wheel angle MA and the target front steering angle δf, a target rotation angle of the electric motor 42 with which the steering angle of the front wheel 10F becomes the target front steering angle δf. Then, the control signal output unit 120 generates, based on the target rotation angle of the electric motor 42, the control signal Cf used for controlling the operation of the VGRS driver 45, and outputs the generated control signal Cf to the VGRS driver 45. Meanwhile, the control signal output unit 120 receives the detected information on the rotation angle θf of the electric motor 42 from the rotation angle sensor 44. The control signal output unit 120 performs a feedback control such that the rotation angle θf becomes the target rotation angle.

Similarly, the control signal output unit 120 calculates, based on the target rear steering angle δr, a target rotation angle of the electric motor 63 with which the steering angle of the rear wheel 10R becomes the target rear steering angle δr. Then, the control signal output unit 120 generates, based on the target rotation angle of the electric motor 63, the control signal Cr used for controlling the operation of the DRS driver 65, and outputs the generated control signal Cr to the DRS driver 65. Meanwhile, the control signal output unit 120 receives the detected information on the rotation angle θr of the electric motor 63 from the rotation angle sensor 64. The control signal output unit 120 performs a feedback control such that the rotation angle θr becomes the target rotation angle.

### <Correction Determination Unit 130>

The correction determination unit 130 determines whether or not the correction condition that “the vehicle 1 is in the oversteer condition and the driver applies the counter-steering” is satisfied.

Regarding the first condition that “the vehicle 1 is in the oversteer condition”, the correction determination unit 130 makes a comparison between the actual yaw rate Yr and a target yaw rate Yr0. The actual yaw rate Yr is detected by the yaw rate sensor 74. The target yaw rate Yr0 is calculated from the steering wheel angle MA and the vehicle speed V by a publicly known method. The steering wheel angle MA is detected by the steering angle sensor 71. The vehicle speed V is detected by the vehicle speed sensor 73. Alternatively, the vehicle speed V may be calculated from the respective rotational speeds of the wheels detected by the wheel speed sensors 72.

The oversteer condition can be defined as a condition in which the actual yaw rate Yr is greater than the target yaw rate Yr0 (i.e. Yr>Yr0). For example, the correction determination unit 130 calculates a difference “Yrd=Yr0−Yr”, and compares the difference Yrd with a threshold value. The threshold value is set to 0, for example. If the difference Yrd is less than the threshold value, then the correction determination unit 130 judges that the vehicle 1 is in the oversteer condition, namely, the first condition is satisfied.

Regarding the second condition that “the driver applies the counter-steering”, the correction determination unit 130 makes a comparison between the actual lateral acceleration Gy and a target lateral acceleration Gy0. The actual lateral acceleration Gy is detected by the lateral acceleration sensor 75. The target lateral acceleration Gy0 is converted from the target yaw rate Yr0 by a publicly known method.

The counter-steering can be defined as a condition in which the actual lateral acceleration Gy is greater than the target lateral acceleration Gy0 (i.e. Gy>Gy0). For example, the correction determination unit 130 calculates a ratio “Gyr=Gy0/Gy”, and compares the ratio Gyr with a threshold value. The threshold value is set to a value equal to or less than 1. If the ratio Gyr is less than the threshold value, then the correction determination unit 130 judges that the driver is applying the counter-steering, namely, the second condition is satisfied. In order to enhance reliability of the judgment, the threshold value may be set to about −0.5.

If both the first condition and the second condition are satisfied, then the correction determination unit 130 judges that the correction condition is satisfied. In this case, the correction determination unit 130 outputs a correction instruction to the gain correction unit 140.

### <Gain Correction Unit 140>

In response to the correction instruction received from the correction determination unit 130, the gain correction unit 140 executes correction processing that corrects the above-mentioned function of the target steering angle calculation unit 110.

In the correction processing, the gain correction unit 140 corrects the function represented by the above-mentioned equation (2) such that an absolute value of the target rear steering angle δr calculated with respect to the same input parameter becomes smaller. To that end, the gain correction unit 140 corrects at least one of the rear steady-state gain Ksr and the rear derivative gain Kdr to be smaller. For example, the gain correction unit 140 corrects both the rear steady-state gain Ksr and the rear derivative gain Kdr.

When correcting the rear steady-state gain Ksr, the gain correction unit 140 multiplies the rear steady-state gain Ksr by a correction coefficient α. The correction coefficient α is equal to or more than 0 and less than 1. As a result of the correction processing, the rear steady-state gain Ksr (absolute value) when the correction condition is satisfied becomes smaller than that when the correction condition is not satisfied.

When correcting the rear derivative gain Kdr, the gain correction unit 140 multiplies the rear derivative gain Kdr by a correction coefficient β. The correction coefficient β is equal to or more than 0 and less than 1. As a result of the correction processing, the rear derivative gain Kdr (absolute value) when the correction condition is satisfied becomes smaller than that when the correction condition is not satisfied.

By executing the above-mentioned correction processing, the absolute value of the target rear steering angle δr calculated with respect to the same input parameter can be made smaller (see FIG. 2). From a perspective of reducing the target rear steering angle δr, the rear steady-state gain Ksr and the rear derivative gain Kdr may be corrected to be zero. In particular, since the drift state is a kind of an extreme state, the rear derivative gain Kdr related to transient characteristics can be actively corrected to be zero. When both the rear steady-state gain Ksr and the rear derivative gain Kdr are corrected to be zero, the target rear steering angle δr to be calculated also becomes zero. In this case, the steering angle of the rear wheel 10R becomes zero and thus the vehicle 1 behaves like a 2WS vehicle.

As described above, the gain map shown in FIG. 5 is determined in advance based on the target vehicle characteristics. During a period when the gain is corrected by the correction processing, a deviation from the target vehicle characteristics occurs. However, the deviation from the target vehicle characteristics is permissible during the drift state, because the drift state is an extreme state deviating from a normal state of motion.

### 2-3. Steering Control Flow

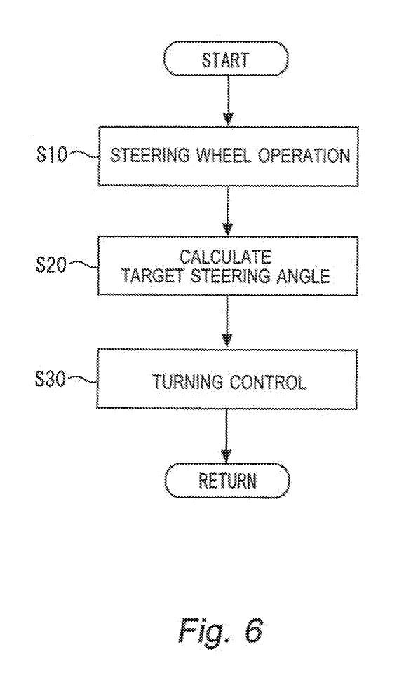

FIG. 6 is a flow chart showing in a summarized manner the steering control according to the present embodiment. A flow of the steering control shown in FIG. 6 is executed repeatedly.

Step S10:

The driver operates the steering wheel 20.

Step S20:

The ECU 100 calculates the target front steering angle δf and the target rear steering angle δr based on the input parameter including the steering wheel angle MA.

Step S30:

The ECU 100 outputs, to the front wheel turning device 30, the control signal Cf corresponding to the target front steering angle δf. The front wheel turning device 30 turns the front wheel 10F in accordance with the control signal Cf. In addition, the ECU 100 outputs, to the rear wheel turning device 50, the control signal Cr corresponding to the target rear steering angle δr. The rear wheel turning device 50 turns the rear wheel 10R in accordance with the control signal Cr.

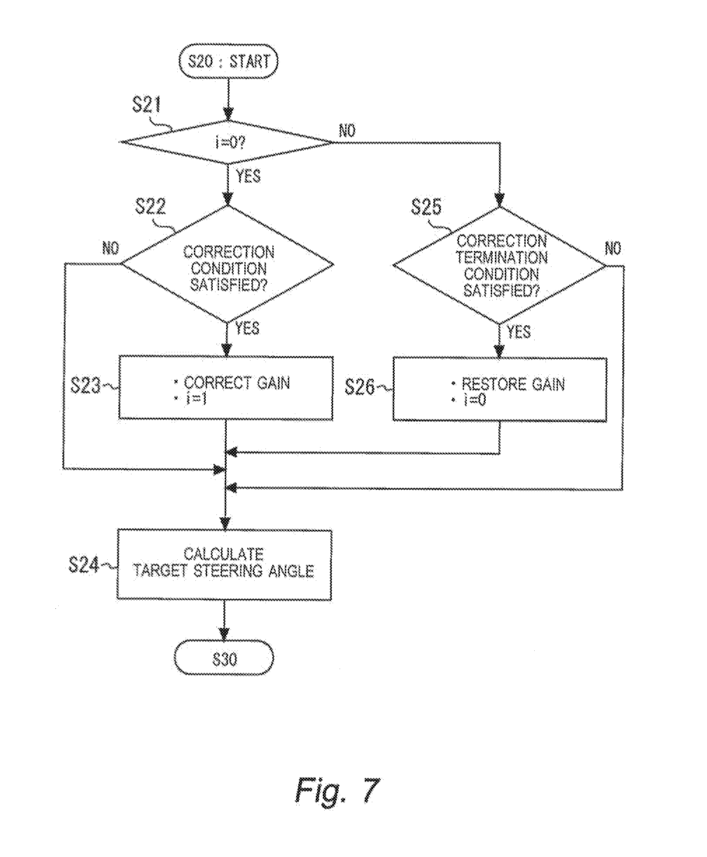

FIG. 7 is a flow chart showing details of Step S20. In FIG. 7, a parameter i, which is used just for convenience, indicates whether or not the above-described correction processing is in execution, namely, whether or not the corrected gain is in use. The parameter i takes a value of “0” or “1”. A case of i=0 means a state where the correction processing is not in execution, that is, the gain before correction is used. On the other hand, a case of i=1 means a state where the correction processing is in execution, that is, the corrected gain is used. An initial value of the parameter i is “0”.

Step S21:

The ECU 100 checks whether or not the parameter i is “0”. If the parameter i is “0” (Step S21; Yes), then the processing proceeds to Step S22. On the other hand, if the parameter i is “1” (Step S21; No), then the processing proceeds to Step S25.

Step S22:

The ECU 100 (the correction determination unit 130) determines whether not the correction condition that “the vehicle 1 is in the oversteer condition and the driver applies the counter-steering” is satisfied. If the correction condition is satisfied (Step S22; Yes), then the processing proceeds to Step S23. On the other hand, if the correction condition is not satisfied (Step S22; No), then the processing proceeds to Step S24.

Step S23:

The ECU 100 (the gain correction unit 140) executes the above-described correction processing to correct the function (gain) used for calculating the target rear steering angle δr. In addition, the ECU 100 sets the parameter i to “1”. After that, the processing proceeds to Step S24.

Step S24:

The ECU 100 (the target steering angle calculation unit 110) uses the input parameter and the function to calculate the target front steering angle δf and the target rear steering angle δr.

Step S25:

When the above-described correction processing (i.e. Step S23) is executed, the parameter i becomes “1”. Accordingly, from the next cycle, not Step S22 but Step S25 is executed. In Step S25, whether or not to terminate the correction processing is judged. For example, when the vehicle 1 returns from the drift state as shown in STATE (d) in the foregoing FIG. 1, the correction processing is no longer necessary. Therefore, when STATE (d) is detected, the correction processing may be terminated.

More specifically, the ECU 100 (the correction determination unit 130) determines whether or not a “correction termination condition” is satisfied. One example of the correction termination condition is that “the correction condition ceases to be satisfied.” That is, when any one of the first condition that “the vehicle 1 is in the oversteer condition” and the second condition that “the driver applies the counter-steering” ceases to be satisfied, it is judged that the correction termination condition is satisfied.

Another example of the correction termination condition is that “the correction condition ceases to be satisfied and the steering wheel 20 passes a neutral position.” At the time when the correction processing is terminated, the rear steady-state gain Ksr and the rear derivative gain Kdr are restored, and thus the calculated target rear steering angle δr may undergo a discontinuous change. If the target rear steering angle δr changes discontinuously, the driver is likely to feel strange about the vehicle behavior. In order to reduce such the feeling of strangeness, it is preferable to restore the gain at a timing when the target rear steering angle δr (i.e. the steering angle of the rear wheel 10R) is as close to zero as possible. From this point of view, it is preferable to add a condition that “the steering wheel 20 passes the neutral position” to the correction termination condition. By monitoring the steering wheel angle MA, the ECU 100 (the correction determination unit 130) can detect that the steering wheel 20 has passed the neutral position. Note that the condition that “the steering wheel 20 passes the neutral position” can be restated as a condition that “the steering wheel angle MA passes a zero point.”

If the correction termination condition is satisfied (Step S25; Yes), then the processing proceeds to Step S26. On the other hand, if the correction termination condition is not satisfied (Step S25; No), then the processing proceeds to Step S24 while the correction processing continues.

Step S26:

The ECU 100 (the gain correction unit 140) terminates the above-described correction processing to restore the function (gain) used for calculating the target rear steering angle δr. In addition, the ECU 100 sets the parameter i to “0”. After that, the processing proceeds to Step S24.

### 2-4. Effects

According to the present embodiment, as described above, the correction condition that “the vehicle 1 is in the oversteer condition and the driver applies the counter-steering” is taken into consideration. A case where the correction condition is satisfied corresponds to a state where the driver has an intention to maintain the drift state. In the case where the correction condition is satisfied, the function used for calculating the target rear steering angle δr is corrected. More specifically, the function is corrected such that the absolute value of the target rear steering angle δr calculated with respect to the same input parameter becomes smaller. This means that steering characteristics of the vehicle 1 change from the 4WS characteristics to be closer to the 2WS characteristics.

That is to say, according to the present embodiment, when it is estimated that the driver has the intention to maintain the drift state, the steering characteristics change from the 4WS characteristics to be closer to the 2WS characteristics. Therefore, occurrence of the vehicle behavior contrary to the driver's intention or the vehicle behavior beyond the driver's expectation can be suppressed. As a result, the driver's feeling of strangeness during the drift running is reduced. That is, according to the present embodiment, it is possible to achieve a vehicle behavior and controllability according to the driver's intention during the drift running.

### 3. Second Embodiment

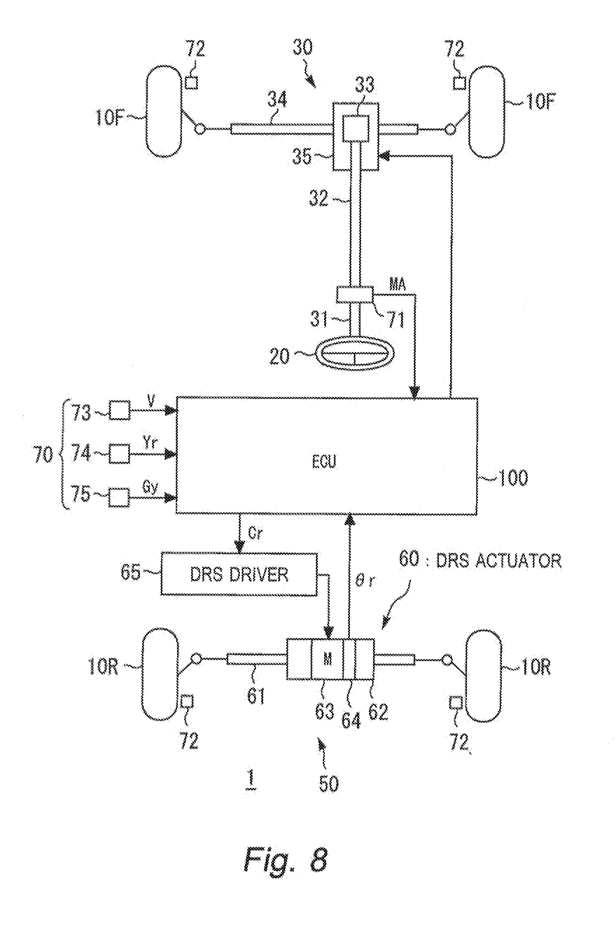

FIG. 8 is a schematic diagram showing a configuration example of the vehicle 1 according to a second embodiment of the present invention. As compared with the configuration of the first embodiment shown in FIG. 3, the VGRS actuator 40 and the VGRS driver 45 of the front wheel turning device 30 are omitted. That is, in the second embodiment, the steering angle of the front wheel 10F is determined depending only on steering of the steering wheel 20. The rear wheel turning device 50 is the same as in the case of the first embodiment.

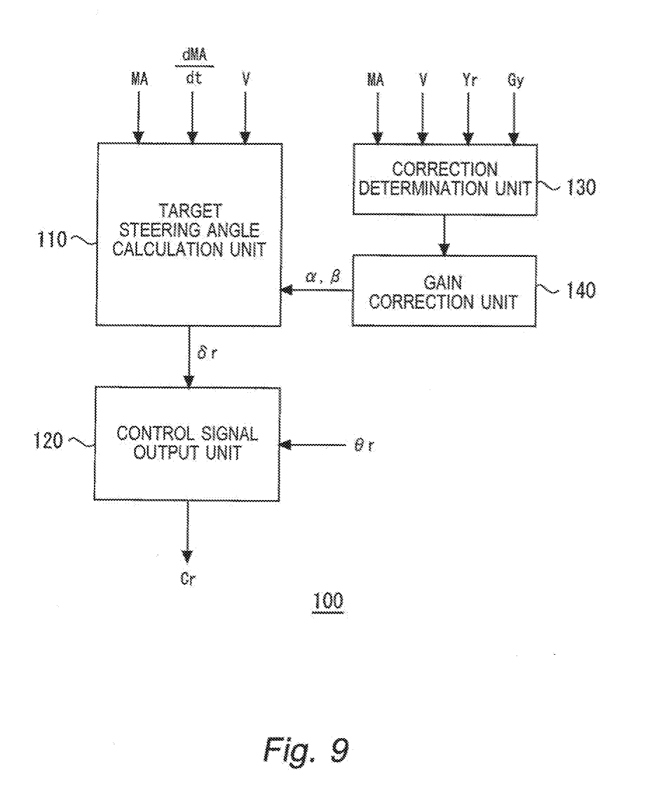

FIG. 9 is a block diagram showing a functional configuration of the ECU 100 in the second embodiment. The target steering angle calculation unit 110 calculates only the target rear steering angle δr based on the input parameter. The control signal output unit 120 generates and outputs the control signal Cr based on the target rear steering angle δr and the rotation angle θr. The correction determination unit 130 and the gain correction unit 140 are the same as in the case of the first embodiment.

The same actions and effects as in the case of the first embodiment can be achieved also in the second embodiment.

What is claimed is:

1. A steering control device for a vehicle, comprising:
a control device configured to calculate a target rear steering angle that is represented as a function of an input parameter including a steering wheel angle; and
a rear wheel turning device configured to turn a rear wheel of the vehicle according to the target rear steering angle,
wherein when a correction condition that the vehicle is in a oversteer condition and a driver applies counter-steering is satisfied, the control device executes correction processing that corrects the function, and
wherein with respect to a same input parameter, an absolute value of the target rear steering angle calculated when the correction processing is in execution is smaller than an absolute value of the target rear steering angle calculated when the correction processing is not in execution.

2. The steering control device according to claim 1,
wherein the function includes a product of a steady-state gain and the steering wheel angle, and
wherein in the correction processing, the control device makes the steady-state gain when the correction condition is satisfied smaller than the steady-state gain when the correction condition is not satisfied.

3. The steering control device according to claim 1,
wherein the function includes a product of a derivative gain and an angular velocity of the steering wheel angle, and
wherein in the correction processing, the control device makes the derivative gain when the correction condition is satisfied smaller than the derivative gain when the correction condition is not satisfied.

4. The steering control device according to claim 1,
wherein after the correction processing is started and when the correction condition ceases to be satisfied and a steering wheel passes a neutral position, the control device terminates the correction processing to restore the function.
